(19) United States
(12) Patent Application Publication
(10) Pub. No.: US 2021/0235737 A1
(43) Pub. Date: Aug. 5, 2021

(54) FORTIFIED NUTRITIONAL SUPPLEMENT

(71) Applicant: APAX OTC Business Development LLC, Castle Rock, CO (US)

(72) Inventor: Sebastien Hebbelinck, Castle Rock, CO (US)

(21) Appl. No.: 17/164,221

(22) Filed: Feb. 1, 2021

Related U.S. Application Data
(60) Provisional application No. 62/970,623, filed on Feb. 5, 2020.

(51) Int. Cl. A23L 33/105; A23L 33/115

(52) U.S. Cl. CPC A23L 33/105; A23L 33/115

(57) ABSTRACT

A fortified nutritional supplement that includes a source material having a full spectrum nutritional complex of a source of a nutrient and a purified nutrient component. The fortified nutritional supplement may provide synergistic effects of the nutrient component in combination with the full spectrum nutritional complex of the source. However, as the source material may have very low concentrations of the nutrient, the use of the purified nutrient component in combination with the source material may facilitate beneficial amounts of the nutrient component in an acceptable, convenient, and reasonable serving amount. Thus, the targeted nutritional benefit of the nutrient component may be achieved with an effective amount of the nutrient component in a reasonable serving while maintaining the full spectrum nutritional complex of the source. One particular implementation involves turmeric root powder as the source material and purified curcumin as the nutrient component.

### RELATED APPLICATIONS

This application claims the benefit of U.S. Provisional Application No. 62/970,623, filed on Feb. 5, 2020, entitled FORTIFIED NUTRITIONAL SUPPLEMENT, the entirety of which is incorporated herein by reference.

### BACKGROUND

Many people use dietary and nutritional supplements in an effort to support good health. Such dietary and nutritional supplements (referred to herein throughout as simply “supplements”) may come in many form factors, including pills, capsules, tablets, oils, gel capsules, powders, or the like. Moreover, a wide variety of supplements are offered that may include one or more specific nutrients that a user wishes to supplement in his or her diet. The specific nutrients included in supplements are often targeted to a specific health benefit that the user of the supplement desires (e.g., antioxidant benefits, anti-inflammatory benefits, improved immune health, vitamin support, etc.)

In an effort to provide beneficial amounts of the one or more nutrients in the supplement, the beneficial ingredients providing the targeted nutrient to be supplemented are often concentrated, isolated, or otherwise refined from a source of the nutrient. This refinement of the nutrient is often performed to reduce the amount of the supplement required to provide beneficial effects. For example, curcumin is a chemical produced by the turmeric plant (Curcuma longa) that provides anti-inflammatory health benefits. While curcumin is naturally occurring in the rhizome or root of the turmeric plant, ingesting a sufficient amount of turmeric root or turmeric root to achieve a beneficial amount of curcumin may be impractical or infeasible. As such, curcumin is often isolated or purified from the turmeric plant for use as a supplement.

### SUMMARY

In view of the foregoing, the present disclosure generally relates to a fortified nutritional supplement. Specifically, it is presently recognized that while prior approaches to isolate or purify a nutritional compound from a source provides convenience and versatility in a supplement; such approaches lose the beneficial synergistic effects that are provided when the source of the nutrient is consumed in whole, thus providing a full complement of compounds that naturally occur in the source of the nutrient. This full complement of compounds that naturally occur in a source of a nutrient is referred to herein as a “full-spectrum” complex of the source of the nutrient. The full spectrum of the plant/root profile includes all compounds that are naturally occurring in the source plant/root of the nutrient as would be present if a user were to consume the source plant/root as whole food.

The present disclosure provides a fortified nutritional supplement that includes a full spectrum source that is fortified with a purified or isolated nutrient component of the source. In this regard, the nutritional supplement provides the convenience benefits of a purified or isolated supplement by providing a beneficial amount of the nutrient in a reduced amount of supplement while also providing the beneficial synergistic effects of the full spectrum of the nutritional complex of the source of the nutrient.

Accordingly, the present disclosure includes a fortified nutritional supplement that includes a source material for a beneficial nutrient. The source material includes a full spectrum nutritional complex of the source of the beneficial nutrient. However, the source material includes an amount of the beneficial nutrient below effective beneficial levels. In turn, the supplement also includes a purified nutrient component comprising a refined amount of the beneficial nutrient at a high concentration. The source material and the purified nutrient component are mixed at a ratio to produce an effective amount of the beneficial nutrient in a standard supplement serving amount. In one example provided herein, the source material comprises turmeric root (e.g., turmeric root powder), and the purified nutrient component comprises curcumin powder.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Other implementations are also described and recited herein.

### DETAILED DESCRIPTIONS

As described above, the present disclosure generally relates to a fortified nutritional supplement. The fortified nutritional supplement provides advantages over either purified supplements of a specific nutrient and the source of the nutrient (e.g., the whole plant). Specifically, the fortified nutritional supplement provides a beneficial amount of a specific nutrient in a reasonable serving size while also providing the synergistic effects of the specific nutrient in combination with the full spectrum nutritional complex of the source of the nutrient (e.g., the whole plant).

The present disclosure is applicable to a number of different specific nutrients and nutrient sources. For example, the following description generally makes reference to a fortified turmeric root powder in which the specifically targeted nutrient comprises curcumin and the source of the nutrient is turmeric root. However, different supplements are also contemplated with different targeted nutrients. Examples of targeted nutrient/source combinations include nitrates/beetroot, cannabidiol/hemp, or other purified nutrients/sources without limitation. As may be appreciated, the sources of the nutrients for the supplements described herein may relate to “superfoods” in which a whole food item (e.g., turmeric root, beetroot, etc.) includes beneficial nutrients, albeit in amounts that may make obtaining an effective beneficial amount infeasible or impractical from the source food alone. Accordingly, the fortified supplements described herein may provide specific advantages of such superfood sources by providing a fortified supplement having both the full spectrum nutritional complex of the source food while also providing beneficial amounts of a targeted nutrient from the superfood source in a serving that is practical, convenient, and/or efficient for a user.

In various embodiments, the fortified supplement product of the present disclosure may be in a variety of forms. For example, the fortified supplement product may be in a powder form, an oil, an aqueous solution, a pill, a tablet, a capsule, or any other appropriate form. In one preferred example, the fortified supplement may be in powder form.

The fortified supplement may comprise a source material of a beneficial nutrient. As described above, the source material may include or be derived from a whole food product such as a plant or a portion of the plant. In one example, the source material comprises turmeric root. The source material may be in the form of a powder, such as a turmeric root powder. Such turmeric root powder may be produced using any appropriate technique including freeze-dry powdering or other techniques. In any regard, the source material may preserve the full spectrum nutritional complex of the source of the nutrient. In the context of turmeric root, such a full-spectrum nutritional complex may include turmerosaccarides and turmerone oil. As may be appreciated, approaches that isolate curcumin from turmeric root may also remove other nutrition components from the turmeric root during processing such that isolated or purified curcumin products do not include the full spectrum nutritional complex of the source turmeric root. While the source material may comprise the full spectrum nutritional complex of the source of the nutrient, the source material may not contain the targeted nutrient in amounts to support a beneficial amount in a reasonable serving size. For instance, a source material comprising turmeric root powder may include curcumin in an amount of less than about 3 percent weight, less than about 2 percent weight, or even less than 1 percent weight. Thus, in order to achieve a beneficial amount of curcumin (e.g., not less than about 500 mg, not less than about 750 mg, not less than about 1,000 mg, not less than about 1,250 mg, or not less than about 1,500 mg), substantial amounts (e.g., kilograms of source material) would need to be consumed to achieve a beneficial amount of the targeted nutrient, curcumin.

Accordingly, the source material may be mixed with a purified nutrient component. In an example, the purified nutrient component is refined or isolated curcumin (e.g., including curcuminoids such as curcumin, dimethoxy curcumin and bis dimethoxy curcumin) Such curcuminoids have been found to have a number of health benefits including, but not limited to antioxidant properties, anti-inflammatory properties, antibacterial properties, antifungal properties, and antiparasitic properties. The purified nutrient component may be derived from the source of the nutrient (e.g., turmeric root). The purified nutrient component may include not less than about 75 weight percent of the targeted nutrient, not less than about 80 weight percent of the targeted nutrient, not less than about 85 weight percent of the targeted nutrient, not less than about 90 weight percent of the targeted nutrient, not less than about 95 weight percent of the targeted nutrient, or not less than about 99 weight percent of the targeted nutrient. However, during the processing of the purified nutrient component, other nutrients present in the source of the nutrient may be removed. Accordingly, the synergistic effects of the nutrient in combination with the full spectrum of the nutritional complex of the source may be lost.

A fortified nutritional supplement may be provided that includes a mixture of a source material and a purified nutrient component to provide both effective amounts of the targeted nutrient while preserving the synergistic effects of the full spectrum of the nutritional complex of the source. The source material may include turmeric powder and the purified nutrient component may include curcumin powder. The mixture of the source material and the purified nutrient component may include a ratio of the source material and the purified nutrient component to provide an effective amount of the targeted nutrient in a reasonable serving while also providing the full spectrum of the nutritional complex of the source. For example, a reasonable serving may include not more than about 2.5 g of the fortified supplement, not more than about 5 g of the fortified supplement, not more than about 7.5 g of the fortified supplement, or not more than about 10 g of the fortified supplement. A beneficial amount of the targeted nutrient may include not less than about 250 mg, not less than about 500 mg, not less than about 750 mg, not less than about 1,000 mg, not less than about 1,250 mg, or not less than about 1,500 mg.

In this regard, the fortified supplement may include not less than about 2 weight percent of the purified nutrient component, not less than about 4 weight percent of the purified nutrient component, not less than about 5 weight percent of the purified nutrient component, not less than about 6.5 weight percent of the purified nutrient component, or not less than about 10 weight percent of the purified nutrient component. The fortified supplement may include not more than about 80 weight percent of the purified nutrient component, not more than about 75 weight percent of the purified nutrient component, not more than about 60 weight percent of the purified nutrient component, not more than about 50 weight percent of the purified nutrient component, not more than about 25 weight percent of the purified nutrient component, or not more than about 21.5 weight percent of the purified nutrient component. Any appropriate range bounded by any combination of the foregoing lower bounds and the foregoing upper bounds may be provided without limitation except for the upper bound is greater than the lower bound.

In some examples, the fortified nutritional supplement may include an absorption promotion agent. The absorption promotion agent may include any appropriate chemical or combination of chemicals to support absorption by a body of the targeted nutrient component and the full spectrum nutritional complex of the source material. Contemplated absorption promotion agents include, but are not limited to, at least one of black pepper or medium-chain triglyceride (MCT) oil.

One aspect of the present disclosure includes a fortified nutritional supplement. The supplement includes a source material of a beneficial nutrient. The source material includes a full spectrum nutritional complex of the source of the beneficial nutrient chemical and an amount of the beneficial nutrient below effective beneficial levels. The supplement also includes a purified nutrient component comprising a refined amount of the beneficial nutrient at a high concentration. The source material and the purified nutrient component are mixed at a ratio to produce an effective amount of the beneficial nutrient in a standard supplement serving amount.

Implementations of this aspect may include any or all of the following features. In an implementation, the source material includes turmeric root, and the beneficial nutrient includes curcumin The source material may be full-spectrum turmeric root powder and the purified nutrient component may be purified curcumin powder.

In one implementation, the supplement includes the purified nutrient component in an amount of not less than about 2 weight percent and not greater than about 80 weight percent. In another implementation, the supplement includes the purified nutrient component in an amount of not less than about 4 weight percent and not more than about 50 weight percent. In another implementation, the supplement includes the purified nutrient component in an amount of not less than about 5 weight percent and not greater than about 25 weight percent. In another implementation, the supplement includes the purified nutrient component in an amount of not less than about 6.5 weight percent and not greater than about 21.5 weight percent.

In an implementation, the full spectrum turmeric root powder comprises curcumin in an amount of not greater than about 3 weight percent. The purified nutrient component may include curcumin in an amount of not less than about 90 weight percent.

In an implementation, an effective serving size of the supplement includes not greater than about 7 g of the supplement and the effective serving size is not less than about 1000 mg of curcumin In another implementation, an effective serving size of the supplement includes not greater than about 7 g of the supplement and the effective serving size comprises not less than about 1500 mg of curcumin. In yet another implementation, an effective serving size of the supplement includes not greater than about 7 g of the supplement and the effective serving size is not less than about 450 mg of curcumin

In an implementation, the source material includes a full spectrum complex of turmeric root including turmerosaccharides and turmerone oil.

In an implementation, the supplement also includes an absorption promotion agent comprising at least one of black pepper or medium-chain triglyceride (MCT) oil.

Another aspect of the present disclosure includes a method for preparing a fortified nutritional supplement. The method includes preparing a source material for a beneficial nutrient. The source material includes a full spectrum nutritional complex of the source of the beneficial nutrient chemical and an amount of the beneficial nutrient below effective beneficial levels. The method also includes providing a purified nutrient component that includes a refined amount of the beneficial nutrient at a high concentration. The method further includes mixing the source material and the purified nutrient component at a ratio to produce an effective amount of the beneficial nutrient in a standard supplement serving amount.

Implementations of this aspect may include any or all of the following features. In an implementation, the source material includes full-spectrum turmeric root powder and the beneficial nutrient includes purified curcumin powder. In this context, the method may also include generating the source material by powdering turmeric root. The method may also include isolating the beneficial nutritional component from the source material to produce the purified nutrient component.

In an implementation, the mixing results in the supplement, including the purified nutrient component in an amount of not less than about 2 weight percent and not greater than about 80 weight percent. In another implementation, the mixing results in the supplement comprising the purified nutrient component in an amount of not less than about 4 weight percent and not more than about 50 weight percent. In still another implementation, the mixing results in the supplement comprising the purified nutrient component in an amount of not less than about 5 weight percent and not greater than about 25 weight percent. In still a further implementation, the mixing results in the supplement comprising the purified nutrient component in an amount of not less than about 6.5 weight percent and not greater than about 21.5 weight percent.

In an implementation, the full spectrum turmeric root powder includes curcumin in an amount of not greater than about 3 weight percent. The purified nutrient component may include curcumin in an amount of not less than about 90 weight percent.

In an implementation, the method may include measuring and/or administering an effective serving size of the supplement in an amount not greater than about 7 g of the supplement, and the effective serving size comprises not less than about 1000 mg of curcumin. In another implementation, the method includes measuring and/or administering an effective serving size of the supplement that comprises not greater than about 7 g of the supplement and the effective serving size comprises not less than about 1500 mg of curcumin. In yet another implementation, an effective serving size of the supplement includes not greater than about 7 g of the supplement and the effective serving size is not less than about 450 mg of curcumin.

In an implementation, the source material may include a full spectrum complex of turmeric root, including turmerosaccharides and turmerone oil.

In another implementation, the method may include adding to the supplement an absorption promotion agent comprising at least one of black pepper or medium-chain triglyceride (MCT) oil.

What is claimed is:

1. A fortified nutritional supplement, comprising:
a source material of a beneficial nutrient, the source material comprising a full-spectrum nutritional complex of a source of the beneficial nutrient and an amount of the beneficial nutrient below effective beneficial levels;
a purified nutrient component comprising a refined amount of the beneficial nutrient at a high concentration; and
wherein the source material and the purified nutrient component are mixed at a ratio to produce an effective amount of the beneficial nutrient in a standard supplement serving amount.

2. The supplement of claim 1, wherein the source material comprises turmeric root, and the beneficial nutrient comprises curcumin.

3. The supplement of claim 2, wherein the source material comprises full-spectrum turmeric root powder, and the purified nutrient component comprises purified curcumin powder.

4. The supplement of claim 3, wherein the supplement comprises the purified nutrient component in an amount of not less than about 2 weight percent and not greater than about 80 weight percent.

5. The supplement of claim 3, wherein the supplement comprises the purified nutrient component in an amount of not less than about 4 weight percent and not more than about 50 weight percent.

6. The supplement of claim 3, wherein the supplement comprises the purified nutrient component in an amount of not less than about 5 weight percent and not greater than about 25 weight percent.

7. The supplement of claim 3, wherein the supplement comprises the purified nutrient component in an amount of not less than about 6.5 weight percent and not greater than about 21.5 weight percent.

8. The supplement of claim 3, wherein the full spectrum turmeric root powder comprises curcumin in an amount of not greater than about 3 weight percent.

9. The supplement of claim 8, wherein the purified nutrient component comprises curcumin in an amount of not less than about 90 weight percent.

10. The supplement of claim 3, wherein an effective serving size of the supplement includes not greater than about 7 g of the supplement and the effective serving size is not less than about 450 mg of curcumin

11. The supplement of claim 3, wherein an effective serving size of the supplement comprises not greater than about 7 g of the supplement, and the effective serving size comprises not less than about 1000 mg of curcumin

12. The supplement of claim 3, wherein an effective serving size of the supplement comprises not greater than about 7 g of the supplement, and the effective serving size comprises not less than about 1500 mg of curcumin.

13. The supplement of claim 3, wherein the source material comprises a full spectrum complex of turmeric root including turmerosaccharides and turmerone oil.

14. The supplement of claim 3, further comprising:
an absorption promotion agent comprising at least one of black pepper or medium-chain triglyceride (MCT) oil.

15. A method for preparing a fortified nutritional supplement, comprising:
preparing a source material for a beneficial nutrient, the source material comprising a full-spectrum nutritional complex of a source of the beneficial nutrient and an amount of the beneficial nutrient below effective beneficial levels;
providing a purified nutrient component comprising a refined amount of the beneficial nutrient at a high concentration; and
mixing the source material and the purified nutrient component at a ratio to produce an effective amount of the beneficial nutrient in a standard supplement serving amount.

16. The method of claim 15, wherein the source material comprises full-spectrum turmeric root powder and the beneficial nutrient comprises purified curcumin powder, the method further comprising:
generating the source material by powdering turmeric root.

17. The method of claim 16, further comprising:
isolating the beneficial nutrient from the source material to produce the purified nutrient component.

18. The method of claim 16, wherein the mixing results in the supplement comprising the purified nutrient component in an amount of not less than about 2 weight percent and not greater than about 80 weight percent.

19. The method of claim 16, wherein the mixing results in the supplement comprising the purified nutrient component in an amount of not less than about 4 weight percent and not more than about 50 weight percent.

20. The method of claim 16, wherein the mixing results in the supplement comprising the purified nutrient component in an amount of not less than about 5 weight percent and not greater than about 25 weight percent.

21. The method of claim 16, wherein the mixing results in the supplement comprising the purified nutrient component in an amount of not less than about 6.5 weight percent and not greater than about 21.5 weight percent.

22. The method of claim 16, wherein the full spectrum turmeric root powder comprises curcumin in an amount of not greater than about 3 weight percent.

23. The method of claim 22, wherein the purified nutrient component comprises curcumin in an amount of not less than about 90 weight percent.

24. The method of claim 16, further comprising:
measuring an effective serving size of the supplement includes not greater than about 7 g of the supplement and the effective serving size is not less than about 450 mg of curcumin.

25. The method of claim 16, further comprising:
measuring an effective serving size of the supplement in an amount not greater than about 7 g of the supplement and the effective serving size comprises not less than about 1000 mg of curcumin

26. The method of claim 16, further comprising:
measuring an effective serving size of the supplement comprises not greater than about 7 g of the supplement, and the effective serving size comprises not less than about 1500 mg of curcumin

27. The method of claim 16, wherein the source material comprises a full spectrum complex of turmeric root including turmerosaccharides and turmerone oil.

28. The method of claim 16, further comprising:
adding to the supplement an absorption promotion agent comprising at least one of black pepper or medium-chain triglyceride (MCT) oil.
